(19) United States
(12) Patent Application Publication
(10) Pub. No.: US 2025/0350188 A1
(43) Pub. Date: Nov. 13, 2025

(54) SWITCHING DEVICE, INSULATED DC/DC CONVERTER, AND AC/DC CONVERTER

(71) Applicant: ROHM CO., LTD., Kyoto (JP)

(72) Inventors: Hiroki KIKUCHI, Kyoto (JP); Satoshi MAEJIMA, Kyoto (JP)

(21) Appl. No.: 19/199,841

(22) Filed: May 6, 2025

(30) Foreign Application Priority Data
May 13, 2024 (JP) 2024-078011

(51) Int. Cl. H02M 1/088; H02M 3/335

(52) U.S. Cl. CPC H02M 1/088; H02M 3/33569

(57) ABSTRACT

A switching device includes a switching transistor provided between a first terminal connected to an inductive load and a second terminal, and turns the switching transistor on and off. A driver turns the switching transistor on by supplying a charging current to a gate of the switching transistor, and turns the switching transistor off by discharging charges stored in the gate of the switching transistor. The driver discharges the stored charges via an external resistor provided outside the switching device and between a resistor connection terminal and a ground.

### CROSS-REFERENCE TO RELATED APPLICATION

The present invention claims priority under 35 U.S.C. § 119 to Japanese Patent Application No. 2024-078011, filed on May 13, 2024, the entire contents of which are incorporated herein by reference.

### TECHNICAL FIELD

The present disclosure relates to a switching device, an insulated DC/DC converter, and an AC/DC converter.

### BACKGROUND

A device that controls a current flowing through an inductive load by switching a switching transistor connected to the inductive load is widely known.

### BRIEF DESCRIPTION OF DRAWINGS

The accompanying drawings, which are incorporated in and constitute a part of the specification, illustrate embodiments of the present disclosure.

FIG. 1 is an overall configuration view of an AC/DC converter according to an embodiment of the present disclosure.

FIG. 2 is an overall configuration view of a DC/DC converter provided in the AC/DC converter of FIG. 1.

FIG. 3 is an external perspective view of a primary-side control device according to an embodiment of the present disclosure.

FIG. 4 is a schematic configuration view of a reference device.

FIG. 5 is a view showing several signal waveforms in the reference device.

FIG. 6 is a view showing several signal waveforms in the reference device.

FIG. 7 is an explanatory view of a method of adjusting a slew rate in the reference device.

FIG. 8 is an explanatory view of a method of adjusting a slew rate in the reference device.

FIG. 9 is a view showing several signal waveforms in a primary-side control device according to an embodiment of the present disclosure.

FIG. 10 is a waveform diagram of a drain voltage when a switching transistor is turned off, according to an embodiment of the present disclosure.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

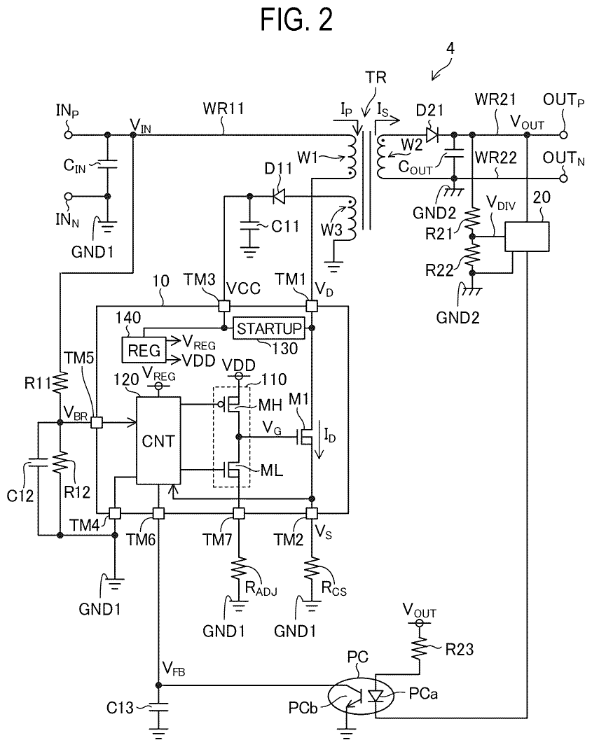

Examples of embodiments of the present disclosure will be specifically described below with reference to the drawings. Throughout the referred drawings, the same parts are denoted by the same reference numerals, and duplicate explanation thereof will be omitted in principle. In addition, in the present disclosure, for the sake of simplification of description, by describing symbols or codes that refer to information, signals, physical quantities, functional parts, circuits, elements, components, and the like, the names of the information, the signals, the physical quantities, the functional parts, the circuits, the elements, the components, and the like, which correspond to the symbols or the codes, may be omitted or abbreviated. For example, a switching transistor referred to by “M1” (see FIG. 2), which will be described later, may be written as a switching transistor M1, or may be abbreviated as a transistor M1, but they all refer to the same thing.

First, some terms used in the description of the embodiments of the present disclosure will be explained. A level refers to a level of potential, and a high level has a higher potential than a low level for any given signal or voltage.

For any transistor configured as a field effect transistor (FET) such as a MOSFET, an on state refers to a state in which a drain and a source of the transistor are electrically connected to each other, and an off state refers to a state in which the drain and the source of the transistor are electrically disconnected (cut-off state) from each other. The same also applies to transistors that are not classified as FETs. Unless otherwise specified, a MOSFET is regarded as an enhancement type MOSFET. MOSFET is an abbreviation for “metal-oxide-semiconductor field-effect transistor.” In addition, it may be considered that a back gate is short-circuited to a source in any MOSFET unless otherwise specified.

Hereinafter, an on state and an off state of any transistor may be expressed simply as on and off, respectively. For any transistor, switching from the off state to the on state is expressed as turning on, and switching from the on state to the off state is expressed as turning off. Further, for any transistor, a period during which the transistor is in the on state is referred to as an on period, and a period during which the transistor is in the off state is referred to as an off period.

A connection between a plurality of parts forming a circuit, such as arbitrary circuit elements, wirings, and nodes, may be understood to refer to an electrical connection, unless otherwise specified.

When any two voltages to be compared are voltages v1 and v2, “v1>v2” indicates that the voltage v1 is higher than the voltage v2, “v1<v2” indicates that the voltage v1 is lower than the voltage v2, and “v1=v2” indicates that the value of voltage v1 is the same as the value of voltage v2. The same also applies to other equations that include physical quantities other than a voltage.

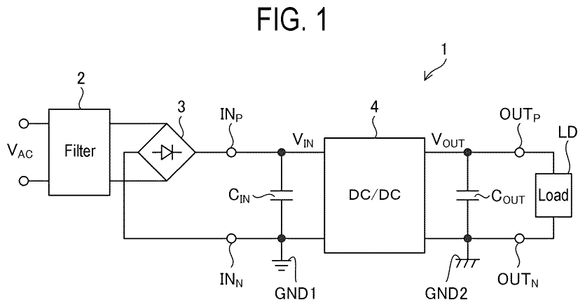

FIG. 1 is an overall configuration view of an AC/DC converter 1 according to an embodiment of the present disclosure. The AC/DC converter 1 includes a filter 2, a rectifier circuit 3, an insulated DC/DC converter 4, an input capacitor C_{IN}, and an output capacitor C_{OUT}. The output capacitor C_{OUT} may be considered to be included in components of the DC/DC converter 4. Although details will become clear from the following description, the AC/DC converter 1 generates a secondary-side output voltage V_{OUT} from a primary-side input voltage V_{IN} by a switching system using a transformer.

The AC/DC converter 1 is composed of a primary-side circuit disposed on a primary side of the AC/DC converter 1 and a secondary-side circuit disposed on a secondary side of the AC/DC converter 1, and the primary-side circuit and the secondary-side circuit are electrically insulated from each other. In the present disclosure, insulation means that transmission of DC signals and power is blocked. The filter 2, the rectifier circuit 3, and the input capacitor C_{IN} are disposed in the primary-side circuit, and the output capacitor C_{OUT} is disposed in the secondary-side circuit. The DC/DC converter 4 is disposed across the primary-side circuit and the secondary-side circuit. In addition, when focusing on the DC/DC converter 4, the primary-side circuit may be understood as a circuit disposed on the primary-side of circuits constituting the DC/DC converter 4, and the secondary-side circuit may be understood as a circuit disposed on the secondary-side of the circuits constituting the DC/DC converter 4.

The ground in the primary-side circuit is referred to as “GND1,” and the ground in the secondary-side circuit is referred to as “GND2.” Any voltage or signal in the primary-side circuit, including the primary-side input voltage V_{IN}, is a voltage or signal with the ground GND1 as a reference, and has a potential as seen from the ground GND1. Any voltage or signal in the secondary-side circuit, including the secondary-side output voltage V_{OUT}, is a voltage or signal with the ground GND2 as a reference, and has a potential as seen from the ground GND2. In each of the primary-side circuit and the secondary-side circuit, the ground refers to a reference conductor having a reference potential of 0 V (zero volts), or refers to the reference potential itself. However, since the ground GND1 and the ground GND2 are insulated from each other, they may have different potentials. The reference conductor is formed of a conductor such as metal. Any circuit provided in the primary-side circuit and requiring a power supply voltage can be driven by using a voltage based on the primary-side input voltage V_{IN} as the power supply voltage. Any circuit provided in the secondary-side circuit and requiring a power supply voltage can be driven by using a voltage based on the secondary-side output voltage V_{OUT} as the power supply voltage.

The filter 2 removes noise from an AC voltage V_{AC} input to the AC/DC converter 1. The AC voltage V_{AC} may be a commercial AC voltage. The rectifier circuit 3 is a diode bridge circuit that full-wave rectifies the AC voltage V_{AC} supplied via the filter 2. The input capacitor C_{IN} generates a DC voltage by smoothing the full-wave rectified voltage. For this reason, the input capacitor C_{IN} may also be called a smoothing capacitor. The DC voltage generated by the input capacitor C_{IN} functions as the primary-side input voltage V_{IN}. The primary-side input voltage V_{IN} is applied between a pair of input terminals IN_{P} and IN_{N}. Specifically, a terminal on a low-potential side of the input capacitor C_{IN} is connected to both the ground GND1 and the input terminal IN_{N}, and a terminal on a high-potential side of the input capacitor C_{IN} is connected to the input terminal IN_{P}. Further, the primary-side input voltage V_{IN} is applied to the input terminal IN_{P} with a potential at the input terminal IN_{N} as a reference. Strictly speaking, the primary-side input voltage V_{IN} is a pulsating voltage having a frequency corresponding to a frequency of the AC voltage V_{AC}.

The DC/DC converter 4 performs power conversion (DC-DC conversion) of the primary-side input voltage V_{IN} by using a switching system to generate the secondary-side output voltage V_{OUT} stabilized at a predetermined target voltage V_{TG}. The secondary-side output voltage V_{OUT} is a DC voltage corresponding to an output voltage of the AC/DC converter 1, and is applied between a pair of output terminals OUT_{P} and OUT_{N}. Specifically, a terminal on a low-potential side of the output capacitor C_{OUT} is connected to both the ground GND2 and the output terminal OUT_{N}, and a terminal on a high-potential side of the output capacitor C_{OUT} is connected to the output terminal OUT_{P}. Further, the secondary-side output voltage V_{OUT} is applied to the output terminal OUT_{P} with a potential at the output terminal OUT_{N} as a reference. The pair of input terminals IN_{P} and IN_{N} may be considered to correspond to an input terminal pair in the DC/DC converter 4, and the pair of output terminals OUT_{P} and OUT_{N} may be considered to correspond to an output terminal pair in the AC/DC converter 1 or the DC/DC converter 4.

A load LD is also shown in FIG. 1. The load LD may be considered as a load of the AC/DC converter 1 or, when focusing on the DC/DC converter 4, may be considered as a load of the DC/DC converter 4. The load LD is any load that is connected to the pair of output terminals OUT_{P} and OUT_{N} and is driven based on the secondary-side output voltage V_{OUT}. For example, the load LD is a microcomputer, a digital signal processor (DSP), a power supply circuit, a lighting device, an analog circuit, or a digital circuit.

FIG. 2 shows an internal configuration of the DC/DC converter 4 provided in the AC/DC converter 1. The DC/DC converter 4 includes a transformer TR, which is a power transformer having a primary-side winding W1 and a secondary-side winding W2. The DC/DC converter 4 in FIG. 2 adopts a flyback system, in which the primary-side winding W1 and the secondary-side winding W2 in the transformer TR are magnetically coupled with each other in reverse polarity while being electrically insulated from each other. The transformer TR further includes an auxiliary winding W3 on the primary-side.

The primary-side circuit of the DC/DC converter 4 (i.e., the primary-side circuit of the AC/DC converter 1) includes, in addition to the primary-side winding W1 and the auxiliary winding W3, a primary-side control device 10, which is an example of a switching device, the input capacitor C_{IN}, a rectifier diode D11, capacitors C11 to C13, voltage-dividing resistors R11 and R12, a sense resistor Rcs, and an adjustment resistor RADJ. As described above, the input capacitor C_{IN} is provided between the input terminals IN_{P} and IN_{N}, and the primary-side input voltage V_{IN} is applied across the input capacitor C_{IN}.

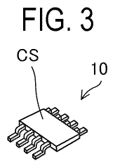

FIG. 3 shows an external perspective view of the primary-side control device 10. The primary-side control device 10 is an electronic component, which includes a semiconductor chip having a semiconductor integrated circuit formed on a semiconductor substrate, a housing (package) CS accommodating the semiconductor chip, and a plurality of external terminals exposed from the housing CS to the outside of the primary-side control device 10. The primary-side control device 10 is formed by encapsulating the semiconductor chip in the housing CS made of resin. In addition, the number of the external terminals and a type of the housing of the primary-side control device 10 shown in FIG. 3 are merely examples, and may be designed arbitrarily. Terminals TM1 to TM7 shown in FIG. 2 are the external terminals provided in the primary-side control device 10. Other external terminals may also be provided in the primary-side control device 10. In addition, the terminal TM1 may be formed of two or more external terminals. The same also applies to the terminals TM2 to TM7.

Referring again to FIG. 2, the primary-side control device 10 includes a switching transistor M1, a driver 110, a control circuit 120, a startup circuit 130, and an internal power supply circuit 140. A semiconductor chip on which the switching transistor M1 is formed and a semiconductor chip on which the driver 110, the control circuit 120, the startup circuit 130, and the internal power supply circuit 140 are formed are accommodated in the housing CS. However, the switching transistor M1, the driver 110, the control circuit 120, the startup circuit 130, and the internal power supply circuit 140 may be formed on a single semiconductor chip.

The driver 110 includes a transistor MH, which is a high-side transistor, and a transistor ML, which is a low-side transistor. The transistors M1 and ML are configured as N-channel MOSFETs. The transistor MH is configured as a P-channel MOSFET.

A first end of the primary-side winding W1 is connected to a wiring WR11, which is connected to the input terminal IN_{P} and to which the primary-side input voltage V_{IN} is applied. Therefore, the primary-side input voltage V_{IN} is applied to the first end of the primary-side winding W1. A second end of the primary-side winding W1 is connected to the terminal TM1. A drain of the switching transistor M1 is connected to the terminal TM1, and a source of the switching transistor M1 is connected to the terminal TM2. That is, the switching transistor M1 is connected in series to the primary-side winding W1. The sense resistor R_{CS} is provided between the terminal TM2 and the ground GND1 outside the primary-side control device 10. Specifically, at a location outside the primary-side control device 10, a first end of the sense resistor R_{CS} is connected to the terminal TM2, and a second end of the sense resistor R_{CS} is connected to the ground GND1.

A voltage at the terminal TM1 is called a voltage V_{D}, and a voltage at the terminal TM2 is called a voltage V_{S}. The voltage V_{D} corresponds to a drain voltage of the switching transistor M1, and the voltage V_{S} corresponds to a source voltage of the switching transistor M1. A current flowing through the primary-side winding W1 is called a primary-side current I_{P}. During an on period of the switching transistor M1, the primary-side current I_{P} flows from the input terminal IN_{P} through the primary-side winding W1 and a channel of the switching transistor M1. The voltage V_{S} is a voltage generated across the sense resistor R_{CS} (i.e., a voltage drop across the sense resistor R_{CS}), and has a voltage value proportional to a drain current I_{P} of the switching transistor M1 (more specifically, proportional to an instantaneous value of the drain current ID).

A first end of the auxiliary winding W3 is connected to an anode of the rectifier diode D11, and a second end of the auxiliary winding W3 is connected to the ground GND1. A cathode of the rectifier diode D11 is connected to both a first end of the capacitor C11 and the terminal TM3. A second end of the capacitor C11 is connected to the ground GND1. A voltage VCC at the terminal TM3 functions as a power supply voltage for the primary-side control device 10. The terminal TM4 is a ground terminal connected to the ground GND1.

A first end of the voltage-dividing resistor R11 is connected to the wiring WR11. A second end of the voltage-dividing resistor R11 is connected to the terminal TM5, a first end of the voltage-dividing resistor R12, and a first end of the capacitor C12. A second end of the voltage-dividing resistor R12 and a second end of the capacitor C12 are connected to the ground GND1. A voltage V_{BR} at the terminal TM5 is a divided voltage of the primary-side input voltage V_{IN}. The terminal TM6 is connected to a first end of the capacitor C13, and a second end of the capacitor C13 is connected to the ground GND1. A voltage at the terminal TM6 is called a feedback voltage V_{FB}. The adjustment resistor R_{ADJ}, which is an external resistor, is provided between the terminal TM7 and the ground GND1 outside the primary-side control device 10. That is, at a location outside the primary-side control device 10, a first end of the adjustment resistor R_{ADJ} is connected to the terminal TM7, and a second end of the adjustment resistor R_{ADJ} is connected to the ground GND1. The terminal TM7 is an example of a resistor connection terminal.

In the primary-side control device 10, a source of the transistor MH is connected to a node to which an internal power supply voltage VDD is applied, a drain of the transistor MH and a drain of the transistor ML are connected in common to a gate of the switching transistor M1, and a source of the transistor ML is connected to the terminal TM7. Therefore, the terminal TM7 and the adjustment resistor R_{ADJ} are interposed in series between the source of the transistor ML and the ground GND1. A gate voltage of the switching transistor M1 is referred to by a symbol “V_{G}.”

The control circuit 120 is connected to the terminals TM2, TM4, TM5, and TM6, and is also connected to gates of the transistors MH and ML. The control circuit 120 operates based on an internal power supply voltage V_{REG} with a potential of the ground GND1 as a reference. The primary-side circuit of the DC/DC converter 4 is provided with a self-power supply circuit that generates the power supply voltage VCC, and the self-power supply circuit is formed by the auxiliary winding W3, the rectifier diode D11, the capacitor C11, and the startup circuit 130. The startup circuit 130 is connected to the terminals TM1 and TM3. Before switching drive of the switching transistor M1 is started, the startup circuit 130 generates the power supply voltage VCC based on the voltage V_{D} at the terminal TM1. As described above, the power supply voltage VCC is the voltage at the terminal TM3. The power supply voltage VCC is a positive voltage lower than the primary-side input voltage V_{IN}. After the switching drive of the switching transistor M1 is started, a voltage induced in the auxiliary winding W3 based on a magnetic flux generated in the primary-side winding W1 is rectified and smoothed by the rectifier diode D11 and the capacitor C11, so that the power supply voltage VCC continues to be applied to the terminal TM3.

The internal power supply circuit 140 is connected to the terminal TM3, and generates the internal power supply voltages V_{REG} and VDD based on the power supply voltage VCC. The internal power supply voltages V_{REG} and VDD each have a positive DC voltage value (and therefore are higher than the potential of the ground GND1). The internal power supply voltage V_{REG} is supplied to the control circuit 120, and the internal power supply voltage VDD is supplied to the driver 110. The internal power supply voltages V_{REG} and VDD may be a common voltage.

The secondary-side circuit of the DC/DC converter 4 (i.e., the secondary-side circuit of the AC/DC converter 1) includes, in addition to the secondary-side winding W2, a secondary-side control device 20, a rectifier diode D21, an output capacitor C_{OUT}, voltage-dividing resistors R21 and R22, and a resistor R23. A first end of the secondary-side winding W2 is connected to an anode of the rectifier diode D21, and a cathode of the rectifier diode D21 is connected to a wiring WR21. A second end of the secondary-side winding W2 is connected to a wiring WR22. The wiring WR21 is connected to the output terminal OUT_{P}, and the wiring WR22 is connected to the output terminal OUT_{N} and the ground GND2. As described above, the output capacitor C_{OUT} is provided between the output terminals OUT_{P} and OUT_{N}, and the secondary-side output voltage V_{OUT} is applied across the output capacitor C_{OUT} (and therefore between the wiring WR21 and WR22). A current flowing through the secondary-side winding W2 is called a secondary-side current I_{S}. During all or a part of an off period of the switching transistor M1, the secondary-side current I_{S} flows from the wiring WR22 toward the wiring WR21 through the secondary-side winding W2 and the rectifier diode D21.

A first end of the voltage-dividing resistor R21 is connected to the wiring WR21. A second end of the voltage-dividing resistor R21 is connected to a first end of the voltage-dividing resistor R22, and a second end of the voltage-dividing resistor R22 is connected to the ground GND2. A connection node between the voltage-dividing resistors R21 and R22 is connected to the secondary-side control device 20. In addition, the secondary-side control device 20 is connected to the ground GND2 and the wiring WR21. The secondary-side control device 20 is driven based on the secondary-side output voltage V_{OUT} with a potential of the ground GND2 as a reference. A voltage V_{DIV} at the connection node between the voltage-dividing resistors R21 and R22 is a divided voltage of the secondary-side output voltage V_{OUT}.

In the DC/DC converter 4, a photocoupler PC is provided across the primary-side circuit and the secondary-side circuit. The photocoupler PC has a light emitting element PCa provided in the secondary-side circuit and a light receiving element PCb provided in the primary-side circuit. A first end of the resistor R23 is connected to a node to which the secondary-side output voltage V_{OUT} is applied, and the light emitting element PCa is provided between a second end of the resistor R23 and the secondary-side control device 20. The light receiving element PCb is connected in parallel to the capacitor C13.

An operation of the DC/DC converter 4 configured as described above will be described. The control circuit 120 has a brownout function that causes the switching drive of the switching transistor M1 not to be executed when the voltage V_{BR} at the terminal TM5 is lower than a predetermined brownout threshold voltage. In the following, unless otherwise specified, it is assumed that the voltage V_{BR} is maintained to be equal to or higher than the brownout threshold voltage and the power supply voltage VCC is sufficiently high so that the primary-side control device 10 can operate normally.

The control circuit 120 controls gate potentials of the transistors MH and ML to alternately turn the transistors MH and ML on and off, thereby switching the switching transistor M1. Specifically, the control circuit 120 controls the gate potentials of the transistors MH and ML individually to set a state of the driver 110 to one of an output high state, an output low state, and a both off state. In the output high state, the transistor MH is in an on state and the transistor ML is in an off state. In the output low state, the transistor MH is in an off state and the transistor ML is in an on state. In the both off state, the transistors MH and ML are both in an off state. The control circuit 120 never turns on the transistors MH and ML at the same time.

The control circuit 120 controls the transistor MH to be turned off by supplying a high-level signal to the gate of the transistor MH, and controls the transistor MH to be turned on by supplying a low-level signal to the gate of the transistor MH. The control circuit 120 controls the transistor ML to be turned on by supplying a high-level signal to the gate of the transistor ML, and controls the transistor ML to be turned off by supplying a low-level signal to the gate of the transistor ML. The high-level signal supplied to the gate of the transistor MH or ML by the control circuit 120 has a potential of the internal power supply voltage V_{REG}, and the low-level signal supplied to the gate of the transistor MH or ML by the control circuit 120 has the potential of the ground GND1.

When the driver 110 is switched from the output low state to the output high state with the state in which the switching transistor M1 is turned off as a starting point, as a gate voltage V_{G} of the switching transistor M1 rises toward the internal power supply voltage VDD, the state of the switching transistor M1 switches from the off state to the on state. The internal power supply voltage VDD is higher than a gate threshold voltage of the switching transistor M1. Thereafter, when the driver 110 is switched from the output high state to the output low state, as the gate voltage V_{G} of the switching transistor M1 drops toward the voltage of the ground GND1, the state of the switching transistor M1 switches from the on state to the off state. In the switching drive of the switching transistor M1, the switching transistor M1 is switched repeatedly between the on state and the off state. In addition, in the switching drive of the switching transistor M1, in order to reliably avoid the transistors MH and ML from being turned on simultaneously when the control circuit 120 changes the driver 110 from one of the output low state and the output high state to the other of the output low state and the output high state, the control circuit 120 may set the driver 110 to the both off state for a small dead time.

The driver 110 and the control circuit 120 form a control drive circuit. The control drive circuit (110, 120) controls the gate voltage of the switching transistor M1 by turning on or turning off the transistors MH and ML, thereby turning on or turning off the switching transistor M1. During the on period of the switching transistor M1, the primary-side current I_{P} flows from the wiring WR11 to the ground GND1 through the primary winding W1, the terminal TM1, a channel (between the drain and source) of the switching transistor M1, the terminal TM2, and the sense resistor R_{CS}. During the off-period of the switching transistor M1, the primary-side current I_{P} via the switching transistor M1 is cut off. That is, the control drive circuit (110, 120) controls the primary-side current I_{P} via the switching transistor M1 by performing the switching drive that turns on or turns off the switching transistor M1.

During the on period of the switching transistor M1, the primary-side current I_{P} increases over time, and energy corresponding to the primary-side current I_{P} is stored in the primary-side winding W1. Further, the stored energy is released from the secondary-side winding W2 during the off period of the switching transistor M1 (more specifically, the secondary-side current I_{S} based on the stored energy flows through the rectifier diode D21 during the off period of the switching transistor M1), thereby charging the output capacitor C_{OUT} and obtaining the secondary-side output voltage V_{OUT}.

The secondary-side control device 20 supplies a current, which corresponds to the voltage V_{DIV} generated at the connection node between the voltage-dividing resistors R21 and R22, to the light emitting element PCa of the photocoupler PC. Thus, a current corresponding to an amount of current supplied to the light emitting element PCa is generated in the light receiving element PCb of the photocoupler PC, and the feedback voltage V_{FB} fluctuates. At this time, the secondary-side control device 20 controls the amount of current supplied to the light emitting element PCa so that the voltage V_{DIV} matches a predetermined reference voltage, thereby generating the feedback voltage V_{FB} corresponding to the voltage V_{DIV} in the primary-side circuit. In the primary-side control device 10, as the switching transistor M1 is switched based on the feedback voltage V_{FB}, the secondary-side output voltage V_{OUT} is stabilized at the target voltage V_{TG}.

More specifically, the secondary-side control device 20 compares the voltage V_{DIV} with a predetermined reference voltage V_{REF20} (not shown). When the voltage V_{DIV} is higher than the reference voltage V_{REF20}, the secondary-side control device 20 increases the amount of current supplied to the light emitting element PCa, and when the voltage V_{DIV} is lower than the reference voltage V_{REF20}, the secondary-side control device 20 decreases the amount of current supplied to the light emitting element PCa. The increase in the amount of current supplied to the light emitting element PCa results in a decrease in the feedback voltage V_{FB}, and the decrease in the amount of current supplied to the light emitting element PCa results in an increase in the feedback voltage V_{FB}. The control circuit 120 can switch-drive the switching transistor M1 by a pulse width modulation method. In this case, the control circuit 120 decreases an on-duty of the switching transistor M1 as the feedback voltage V_{FB} decreases, and increases the on-duty of the switching transistor M1 as the feedback voltage V_{FB} increases. This implements a feedback control in which an error between the voltage V_{DIV} and the reference voltage V_{REF20} is maintained at zero or near zero. When “V_{DIV}=V_{REF20},” “V_{OUT}=V_{TG}.” The on-duty of the switching transistor M1 refers to, in each switching period of the switching transistor M1, a ratio of a length of the on period of the switching transistor M1 to a length of the switching period of the switching transistor M1. The control method of the switching transistor M1 by the control circuit 120 is not limited to the pulse width modulation method. Therefore, for example, the control circuit 120 may switch-drive the switching transistor M1 at a switching frequency according to the feedback voltage V_{FB} by a pulse frequency modulation method.

In addition, the voltage V_{S} is input to the control circuit 120. The control circuit 120 can perform overcurrent protection processing based on the voltage V_{S}. Specifically, for example, when the voltage V_{S} exceeds a predetermined overcurrent determination voltage in each switching period of the switching transistor M1, the control circuit 120 performs the overcurrent protection processing to immediately turn off the switching transistor M1. In addition, when it is determined that the switching transistor M1 is in an overcurrent state based on the voltage V_{S}, the control circuit 120 can stop the switching drive of the switching transistor M1 for a certain period of time to keep the switching transistor M1 in an off state.

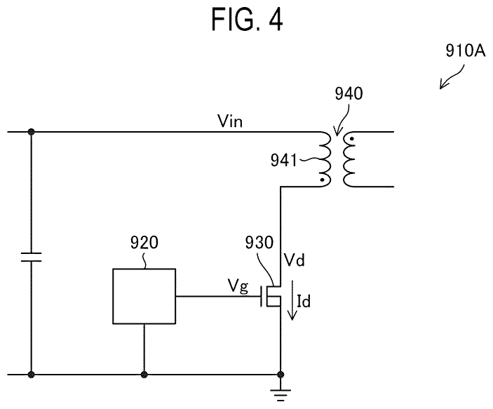

Here, several reference devices will be described for comparison with the configuration of FIG. 2. FIG. 4 is a schematic configuration view of a reference device 910A. In the reference device 910A, a switching transistor 930 is provided in addition to a primary-side control device 920 formed by a semiconductor integrated circuit. The switching transistor 930 is an N-channel MOSFET. An AC/DC converter can be formed by using the reference device 910A. In the reference device 910A, a primary-side input voltage Vin obtained by rectifying an AC voltage is connected to a first end of a primary-side winding 941 of a transformer 940, and a second end of the primary-side winding 941 is connected to a drain of the switching transistor 930. A source of the switching transistor 930 is connected to the ground. The primary-side control device 920 switches the switching transistor 930 by controlling a gate voltage Vg of the switching transistor 930. A drain voltage and a drain current of the switching transistor 930 are referred to by symbols “Vd” and “Id,” respectively.

The primary-side control device 920 supplies charges (positive charges) to the gate of the switching transistor 930, thereby increasing the gate voltage Vg and turning on the switching transistor 930. Thereafter, the primary-side control device 920 discharges charges stored in the gate of the switching transistor 930, thereby decreasing the gate voltage Vg and turning off the switching transistor 930.

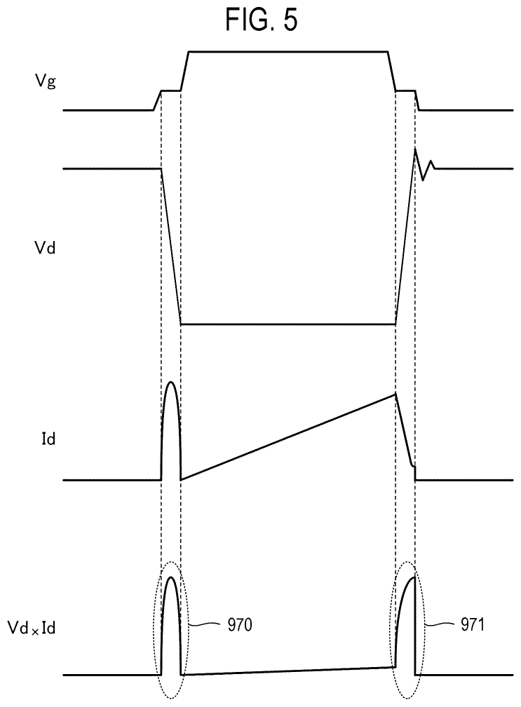

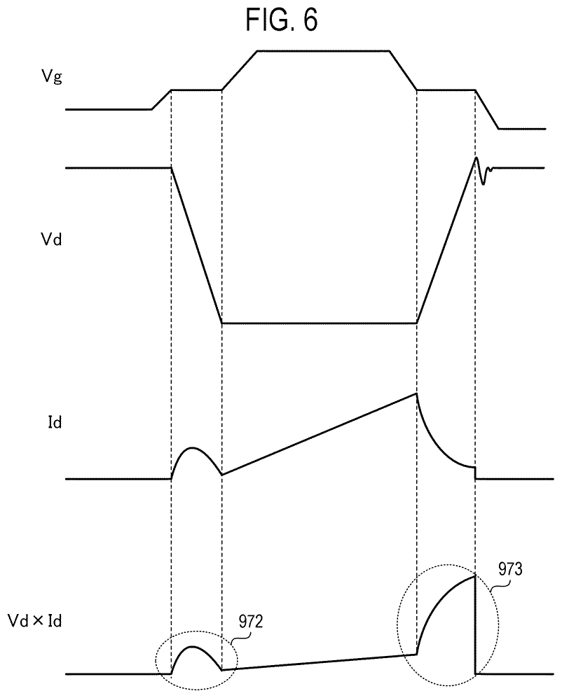

FIG. 5 shows several signal waveforms of the reference device 910A when a charging current and a discharging current of the gate of the switching transistor 930 are relatively large. FIG. 6 shows several signal waveforms of the reference device 910A when the charging current and the discharging current of the gate of the switching transistor 930 are relatively small. A loss generated in the switching transistor 930 is expressed by a product of the drain voltage Vd and the drain current Id.

A large amount of noise is generated due to a sudden change in the drain voltage Vd. By decreasing the charging current of the gate of the switching transistor 930, a falling rate of the drain voltage Vd is decreased, and radiation noise is reduced accordingly. On the other hand, a loss generated when the switching transistor 930 is turned on does not increase at all or hardly increases, even when the falling rate of the drain voltage Vd is decreased. That is, a sum of the products (Vd×Id) in a portion 970 of FIG. 5 is almost the same as a sum of the products (Vd×Id) in a portion 972 of FIG. 6. For this reason, reducing a slew rate when the drain voltage Vd falls is effective for both improving efficiency in power conversion and reducing radiation noise.

In addition, by reducing the discharging current from the gate of the switching transistor 930, a rising rate of the drain voltage Vd is decreased, and the radiation noise is also reduced accordingly. However, a loss generated when the switching transistor 930 is turned off increases significantly in conjunction with the decrease in a slew rate when the drain voltage Vd rises. This corresponds to a sum of the products (Vd×Id) in a portion 973 of FIG. 6 being larger than a sum of the products (Vd×Id) in a portion 971 of FIG. 5, and is caused by the fact that the drain current Id when the switching transistor 930 is turned off is relatively large. That is, there is a trade-off relationship between the loss when the switching transistor 930 is turned off and the radiated noise. Therefore, from the viewpoints of both power conversion efficiency and radiated noise, it is necessary to carefully design the slew rate when the drain voltage Vd rises.

First and second reference methods are considered as methods of reducing and adjusting the radiated noise accompanying fluctuation of the drain voltage Vd.

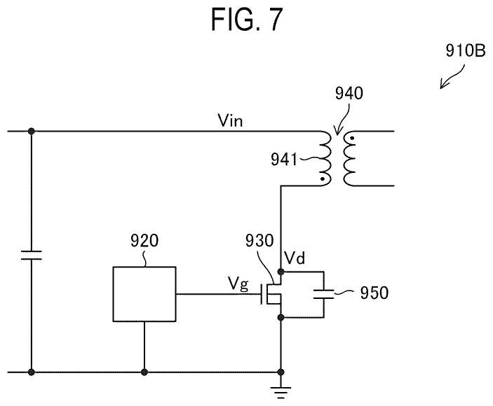

The first reference method is applied to a reference device 910B of FIG. 7. On the basis of the reference device 910A of FIG. 4, the reference device 910B is obtained by providing a capacitor 950 between the drain and the source of the switching transistor 930. By adjusting a capacitance value of the capacitor 950, the slew rate of the drain voltage Vd when the switching transistor 930 is turned on and turned off can be adjusted to a desired slew rate. However, when the primary-side input voltage Vin is generated by full-wave rectifying a commercial AC voltage, a breakdown voltage required for the capacitor 950 is about 600 V. As a result, the reference device 910B requires an expensive and large-sized capacitor 950.

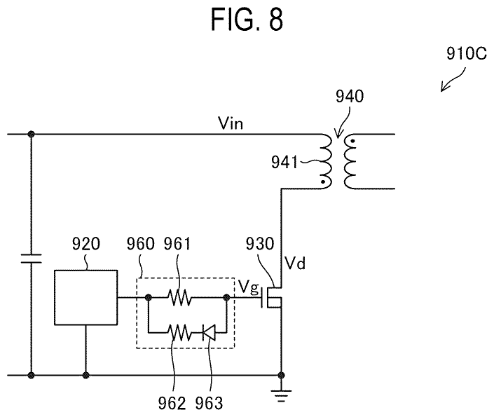

The second reference method is applied to a reference device 910C of FIG. 8. On the basis of the reference device 910A of FIG. 4, the reference device 910C is obtained by inserting a slew rate adjustment circuit 960 between the primary-side control device 920 and the gate of the switching transistor 930. The slew rate adjustment circuit 960 is formed by a resistor (gate resistor) 961 provided between the input/output terminal of the primary-side control device 920 and the gate of the switching transistor 930, and a series circuit of a resistor (gate resistor) 962 and a diode 963 provided between the input/output terminal of the primary-side control device 920 and the gate of the switching transistor 930. In this case, an anode of the diode 963 is connected to the gate of the switching transistor 930, and a cathode of the diode 963 is connected to the input/output terminal of the primary-side control device 920 via the resistor 962.

In the reference device 910C, charging charges for the gate of the switching transistor 930 are supplied from the input/output terminal of the primary-side control device 920 to the gate of the switching transistor 930 via the resistor 961. Therefore, the slew rate of the drain voltage Vd when the switching transistor 930 is turned on (the slew rate when the drain voltage Vd falls) is determined by a value of the resistor 961. On the other hand, when the primary-side control device 920 decreases the gate voltage Vg, the charges stored in the gate of the switching transistor 930 are drawn into the input/output terminal of the primary-side control device 920 via the resistors 961 and 962. Here, when a value of the resistor 962 is set to be sufficiently smaller than the value of the resistor 961, the slew rate of the drain voltage Vd when the switching transistor 930 is turned off (the slew rate when the drain voltage Vd rises) is determined substantially by the value of the resistor 962. Therefore, by adjusting the value of the resistor 962, the slew rate of the drain voltage Vd when the switching transistor 930 is turned off (the slew rate when the drain voltage Vd rises) can be adjusted to a desired slew rate.

As in the reference device 910C, when the switching transistor 930 and the primary-side control device 920 are mounted on a board as separate components, the slew rate of the drain voltage Vd can be easily and arbitrarily adjusted by adjusting the value of the resistor 962, while taking into account power required for the secondary-side and results of EMI tests, and the like. However, when forming a primary-side control device with a built-in switching transistor (corresponding to the switching transistor 930), it is not easy to adjust the slew rate of the drain voltage Vd, and it is necessary to determine a gate resistance of the switching transistor at the time of designing the primary-side control device. When incorporating a primary-side control device with a built-in switching transistor into an AC/DC converter, countermeasures, such as lowering the gate resistance to improve efficiency or raising the gate resistance to reduce radiated noise, cannot be taken.

Taking the facts described above into consideration, in the DC/DC converter 4 of FIG. 2, the adjustment resistor R_{ADJ} is externally connected to the primary-side control device 10 with the built-in switching transistor M1. Starting from a state in which the transistor ML is turned on, the transistor MH is turned off, and the gate voltage V_{G} is 0 V, the control circuit 120 turns the transistor ML off and then turns the transistor MH on, and the driver 110 supplies a charging current to the gate of the switching transistor M1 via the transistor MH from the node to which the internal power supply voltage VDD is applied. Thus, the gate voltage V_{G} of the switching transistor M1 is increased from 0 V toward the internal power supply voltage VDD (on-voltage). In the course in which the gate voltage V_{G} increases from 0 V to the internal power supply voltage VDD, the switching transistor M1 is turned on. Thereafter, when the control circuit 120 turns the transistor MH off and then turns the transistor ML on, the driver 110 discharges the charges stored in the gate of the switching transistor M1 to the ground GND1 via the transistor ML and the adjustment resistor R_{ADJ}. Thus, the gate voltage V_{G} of the switching transistor M1 is decreased from the internal power supply voltage VDD toward 0 V. In the course in which the gate voltage V_{G} decreases from the internal power supply voltage VDD to 0 V, the switching transistor M1 is turned off.

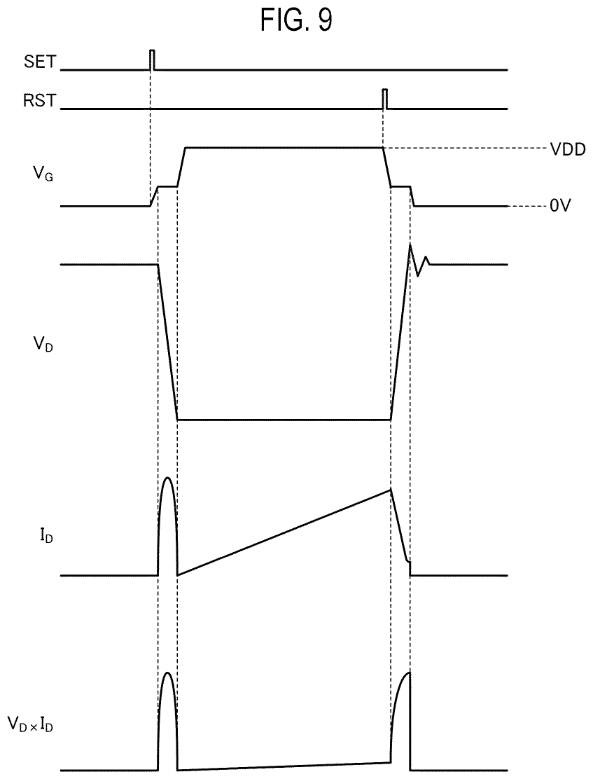

FIG. 9 shows a schematic view of several signal waveforms in the DC/DC converter 4. As an example, it is assumed that the control circuit 120 switches the switching transistor M1 by using a pulse width modulation method. Signals SET and RST are generated in the control circuit 120. Each of the signals SET and RST is a binary signal having a high level or a low level. In principle, the signals SET and RST have a low level. An oscillator (not shown) provided in the control circuit 120 keeps the signal SET to be a high level for a very short time at a predetermined switching frequency. In response to switching the signal SET from a low level to a high level, the control circuit 120 switches the state of the driver 110 from an output low state to an output high state. When the state of the driver 110 switches from the output low state to the output high state, a charging current is supplied to the gate of the switching transistor M1 via the transistor MH from the node to which the internal power supply voltage VDD is applied, and the supply of the charging current continues until the gate voltage V_{G} reaches the internal power supply voltage VDD. In addition, when the switching transistor M1 is turned on, the gate voltage V_{G} is kept substantially close to the gate threshold voltage of the switching transistor M1 during a period when the drain voltage V_{D} falls (mirror period).

Thereafter, a reset circuit (not shown) provided in the control circuit 120 sets the level of the signal RST to a high level for a very short time. In response to switching the signal RST from a low level to a high level, the control circuit 120 switches the state of the driver 110 from an output high state to an output low state. When the state of the driver 110 switches from the output high state to the output low state, a discharging current is generated that discharges the charges stored in the gate of the switching transistor M1 to the ground GND1 via the transistor ML and the adjustment resistor R_{ADJ}, and the discharging continues until the gate voltage V_{G} drops to 0 V. When the switching transistor M1 is turned off, the gate voltage V_{G} is kept substantially close to the gate threshold voltage of the switching transistor M1 during a period when the drain voltage V_{D} rises (mirror period). The reset circuit determines a timing when the level of the signal RST switches from the low level to the high level, based on the feedback voltage V_{FB}. A time difference between a timing when the signal SET switches to a high level and a timing when the signal RST switches to a high level decreases as the feedback voltage V_{FB} decreases and increases as the feedback voltage V_{FB} increases.

When the switching transistor M1 is turned on, the rising rate of the drain voltage V_{D} is increased or decreased by increasing or decreasing the charging current for the gate of the switching transistor M1. By decreasing the falling rate of the drain voltage V_{D}, the radiation noise when the switching transistor M1 is turned on is reduced. On the other hand, a loss generated when the switching transistor M1 is turned on does not increase at all or hardly increases, even when the falling rate of the drain voltage V_{D} is decreased. For this reason, reducing a slew rate at which the drain voltage V_{D} falls is effective for both improving the efficiency in power conversion and reducing radiation noise. Taking this into consideration, an on-resistance of the transistor MH may be set high enough to sufficiently reduce the radiation noise, and the slew rate when the drain voltage V_{D} falls can be reduced by increasing the on-resistance of the transistor MH.

On the other hand, when the switching transistor M1 is turned off, the rising rate of the drain voltage V_{D} is increased or decreased by increasing or decreasing the discharging current from the gate of the switching transistor M1. Therefore, by decreasing the discharging current when the switching transistor M1 is turned off, the radiation noise when the switching transistor M1 is turned off can be reduced. However, as described above with respect to the reference configuration, the loss generated when the switching transistor M1 is turned off increases significantly in conjunction with the decrease in the slew rate when the drain voltage V_{D} rises. That is, there is a trade-off relationship between the loss and the radiation noise when the switching transistor M1 is turned off. Therefore, from the viewpoints of both the power conversion efficiency and the radiation noise, it is necessary to carefully design the slew rate when the drain voltage V_{D} rises.

In this regard, in the DC/DC converter 4 of FIG. 2, it is possible to easily and arbitrarily adjust the slew rate when the drain voltage V_{D} rises by adjusting the resistance value of the adjustment resistor R_{ADJ}. That is, by adjusting the resistance value of the adjustment resistor R_{ADJ}, it is possible to easily and arbitrarily adjust the slew rate of the increase in the drain voltage V_{D}, which is generated when the switching transistor M1 is switched from the on state to the off state. Therefore, it is possible to adjust the power conversion efficiency and the radiation noise characteristics in a well-balanced manner according to the power or the like required on the secondary side.

The on-resistance of the transistor ML may have any value. However, in order for the adjustment described above to function effectively, the on-resistance of the transistor ML may not be increased too much. The on-resistance of the transistor ML may be smaller than the on-resistance of the transistor MH.

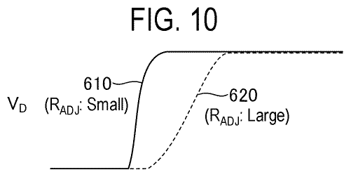

In FIG. 10, a solid line waveform 610 and a broken line waveform 620 show waveforms of the drain voltage V_{D} when the switching transistor M1 is turned off. However, the resistance value of the adjustment resistor R_{ADJ} when the broken line waveform 620 is observed is larger than the resistance value of the adjustment resistor R_{ADJ} when the solid line waveform 610 is observed. It can be recognized that the slew rate when the drain voltage V_{D} rises increases/decreases by the increase/decrease in the resistance value of the adjustment resistor R_{ADJ}. The radiation noise corresponding to the broken line waveform 620 is smaller than the radiation noise corresponding to the solid line waveform 610, but the loss corresponding to the broken line waveform 620 is larger than the loss corresponding to the solid line waveform 610. From the viewpoints of both the power conversion efficiency and the radiation noise, the adjustment resistor R_{ADJ} having an appropriate resistance value may be adopted.

In addition, although the configuration of the DC/DC converter 4 adopting the diode rectification method has been given as an example here, the DC/DC converter 4 may be any insulated DC/DC converter as long as it can generate, from the primary-side voltage Vp applied to the primary-side winding W1, the secondary-side voltage V_{S} on the secondary-side of the transformer TR by a switching system. For example, the DC/DC converter 4 may be configured as a synchronous rectification type by providing a synchronous rectification transistor (not shown) instead of the rectifier diode D21 in the secondary-side circuit. In this case, the synchronous rectification transistor is inserted between one end of the secondary-side winding W2 and the output terminal OUT_{P} or OUT_{N}, and the synchronous rectification transistor is turned on by the secondary-side control device 20 during all or a part of the off period of the switch transistor M1. In addition, for example, the DC/DC converter 4 may be configured as a forward-type insulated DC/DC converter, in which case either the synchronous rectification method or the diode rectification method may be adopted.

The primary-side winding W1 is an example of an inductive load connected to the drain of the switching transistor M1 via the terminal TM1. Although the embodiment in which the technique according to the present disclosure is applied to the AC/DC converter 1 has been described above, application of the technique according to the present disclosure is not limited to the AC/DC converter 1. The technique according to the present disclosure can be applied to any application in which an arbitrary inductive load (coil) is connected to the drain of the switching transistor M1 via the terminal TM1, and in which a current flowing through the inductive load and the switching transistor M1 is controlled by turning the switching transistor M1 on and off.

The types of the channels of the field effect transistors (FETs) shown in the above-described embodiments are merely examples. Without detracting from the spirit of those described above, a type of a channel of any FET may be changed between a P-channel type and an N-channel type.

Any of the transistors described above may be any type of transistor as long as it does not cause any problems. For example, any transistor described above as a MOSFET may be replaced with a junction type FET, an insulated gate bipolar transistor (IGBT), or a bipolar transistor as long as it does not cause any problems. Any transistor has a first electrode, a second electrode, and a control electrode. In FETs, one of the first and second electrodes is a drain, the other of the first and second electrodes is a source, and the control electrode is a gate. In IGBTs, one of the first and second electrodes is a collector, the other of the first and second electrodes is an emitter, and the control electrode is a gate. In bipolar transistors not belonging to IGBTs, one of the first and second electrodes is a collector, the other of the first and second electrodes is an emitter, and the control electrode is a base.

The embodiments of the present disclosure can be appropriately modified in various ways within the scope of the technical ideas shown in the claims. The above-described embodiments are merely examples of the embodiments of the present disclosure, and the meanings of the terms of the present disclosure or configuration requirements are not limited to those described in the above-described embodiments. The specific numerical values shown in the above description are merely examples, and it goes without saying that they can be changed to various numerical values.

### Supplementary Notes

Supplementary notes will be provided for the present disclosure, in which specific configuration examples of the above-described embodiments are shown.

A switching device (10) according to one aspect of the present disclosure includes: a first terminal (TM1) connected to an inductive load (W1); a second terminal (TM2); a switching transistor (M1) provided between the first terminal and the second terminal; a resistor connection terminal (TM7); and a control drive circuit (110, 120) configured to control a current, which flows from a wiring (WR11) to which an input voltage (V_{IN}) is applied to a ground through the inductive load and the switching transistor, by turning the switching transistor on or off by controlling a gate voltage (V_{G}) of the switching transistor, wherein the control drive circuit has a driver (110), which is configured to turn the switching transistor on by supplying a charging current to a gate of the switching transistor and to turn the switching transistor off by discharging charges stored in the gate of the switching transistor, and the driver discharges the stored charges via an external resistor (R_{ADJ}) provided outside the switching device and between the resistor connection terminal and the ground (first configuration).

With the configuration described above, by adjusting the resistance value of the external resistor, it is possible to adjust loss and noise, which are generated when the switching transistor is turned off, in a well-balanced manner.

In the switching device of the first configuration, the driver may have a high-side transistor (MH) provided between a node to which an on-voltage (VDD) higher than a ground voltage is applied and the gate of the switching transistor, and a low-side transistor (ML) provided between the gate of the switching transistor and the resistor connection terminal, the control drive circuit may turn the switching transistor on by directing the gate voltage of the switching transistor toward the on-voltage by turning the low-side transistor off and turning the high-side transistor on, and turn the switching transistor off by directing the gate voltage of the switching transistor toward the ground voltage by turning the high-side transistor off and turning the low-side transistor on, and the resistor connection terminal and the external resistor may be interposed between the low-side transistor and the ground (second configuration).

The switching device of the first or second configuration may further include: a housing (CS) accommodating the switching transistor and the control drive circuit; and a plurality of external terminals exposed from the housing, wherein the plurality of external terminals include the first terminal, the second terminal, and the resistor connection terminal (third configuration).

In the switching device of any one of the first to third configurations, a slew rate of voltage rising in the first terminal when the switching transistor is switched from an on state to an off state is adjusted by adjusting a resistance value of the external resistor (fourth configuration).

An insulated DC/DC converter according to one aspect of the present disclosure is an insulated DC/DC converter (4) configured to generate, by using a power transformer (TR) having a primary-side winding (W1) and a secondary-side winding (W2) insulated from each other, a secondary-side voltage (V_{OUT}) in a secondary side from a primary-side voltage (V_{IN}) in a primary side, and includes the switching device of any one of the first to fourth configurations, wherein the inductive load is the primary-side winding, and the input voltage is the primary-side voltage (fifth configuration).

An AC/DC converter according to one aspect of the present disclosure includes: a rectifier circuit (3) configured to full-wave rectify an AC voltage (V_{AC}); a smoothing capacitor (C_{IN}) configured to generate a DC voltage by smoothing the full-wave rectified voltage; and the insulated DC/DC converter of the fifth configuration, wherein the insulated DC/DC converter generates the secondary-side voltage from the primary-side voltage as the DC voltage (sixth configuration).

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A switching device comprising:
a first terminal connected to an inductive load;
a second terminal;
a switching transistor provided between the first terminal and the second terminal;
a resistor connection terminal; and
a control drive circuit configured to control a current, which flows from a wiring to which an input voltage is applied to a ground through the inductive load and the switching transistor, by turning the switching transistor on or off by controlling a gate voltage of the switching transistor,
wherein the control drive circuit has a driver, which is configured to turn the switching transistor on by supplying a charging current to a gate of the switching transistor and to turn the switching transistor off by discharging charges stored in the gate of the switching transistor, and
wherein the driver discharges the stored charges via an external resistor provided outside the switching device and between the resistor connection terminal and the ground.

2. The switching device of claim 1, wherein the driver has a high-side transistor provided between a node to which an on-voltage higher than a ground voltage is applied and the gate of the switching transistor, and a low-side transistor provided between the gate of the switching transistor and the resistor connection terminal,
wherein the control drive circuit turns the switching transistor on by directing the gate voltage of the switching transistor toward the on-voltage by turning the low-side transistor off and turning the high-side transistor on, and turns the switching transistor off by directing the gate voltage of the switching transistor toward the ground voltage by turning the high-side transistor off and turning the low-side transistor on, and
wherein the resistor connection terminal and the external resistor are interposed between the low-side transistor and the ground.

3. The switching device of claim 1, further comprising:
a housing accommodating the switching transistor and the control drive circuit; and
a plurality of external terminals exposed from the housing,
wherein the plurality of external terminals include the first terminal, the second terminal, and the resistor connection terminal.

4. The switching device of claim 1, wherein a slew rate of voltage rising in the first terminal when the switching transistor is switched from an on state to an off state is adjusted by adjusting a resistance value of the external resistor.

5. An insulated DC/DC converter configured to generate, by using a power transformer having a primary-side winding and a secondary-side winding insulated from each other, a secondary-side voltage in a secondary side from a primary-side voltage in a primary side, comprising:
the switching device of claim 1,
wherein the inductive load is the primary-side winding, and the input voltage is the primary-side voltage.

6. An AC/DC converter comprising:
a rectifier circuit configured to full-wave rectify an AC voltage;
a smoothing capacitor configured to generate a DC voltage by smoothing the full-wave rectified voltage; and
the insulated DC/DC converter of claim 5,
wherein the insulated DC/DC converter generates the secondary-side voltage from the primary-side voltage as the DC voltage.
